(19) United States
(12) Patent Application Publication
(10) Pub. No.: US 2012/0289102 A1
(43) Pub. Date: Nov. 15, 2012

(54) CONTACT HAVING A PROFILED COMPLIANT PIN

(75) Inventors: HURLEY CHESTER MOLL, HERSHEY, PA (US); JOHN MARK MYER, MILLERSVILLE, PA (US); PAUL WITTENSOLDNER, WASHINGTON BORO, PA (US); LEO J. GRAHAM, HERSHEY, PA (US)

(73) Assignee: TYCO ELECTRONICS CORPORATION, BERWYN, PA (US)

(21) Appl. No.: 13/105,482

(22) Filed: May 11, 2011

(51) Int. Cl. H01R 13/02

(52) U.S. Cl. 439/890

(57) ABSTRACT

A contact having a contact body that has a front, a rear and opposite sides that extend between the front and the rear. The contact body extends between a mating end and a mounting end. The mating end is configured to be mated with a corresponding mating contact. The mounting end is configured to be through-hole mounted to a printed circuit board. The mounting end has a profiled section that defines a compliant pin. The profiled section has a necked-down portion being thinner between the front and the rear than adjacent portions of the contact body. The profiled section has an opening through the necked-down portion. The profiled section has a compliant portion at the opening. The compliant portion is wider between the sides than adjacent portions of the contact body.

### BACKGROUND OF THE INVENTION

The subject matter herein relates generally to compliant pin contacts.

Electrical connectors are often mounted to a printed circuit board. The electrical connectors include one or more contacts that are electrically connected to the printed circuit board. In some applications, the contacts have compliant pins that are configured to be through-hole mounted to plated vias of the printed circuit board.

Compliant pins are typically made from strip stock by stamping a work piece to define strips having an outer tear drop shape and then piercing the center of the tear drop shaped portion of the strip to define an opening or eye. Known compliant pins are not without disadvantages. For example, when the outer edges are sheared, tool marks or scratches are created on the sheared edges. The scratches are stress concentration points that potentially lead to fractures when the compliant pin is pressed into the printed circuit board. Additionally, when the electrical connector is used in a harsh environment, such as an automotive application, an aeronautical application, a military application and the like, the electrical connector may be subject to vibration, which can cause further fraction or failure.

Another known problem is that compliant pins will sometimes first engage or interfere with the plating of the printed circuit board in a non-compliant region of the pin. When a non-compliant portion of the pin enters the printed circuit board, damage is caused to the printed circuit board and the plating may be deformed. Deformation of the via is undesirable. Some known compliant pins coin a radius on the outer edges to allow the compliant pin to travel further into the via before interfering with the plating. Coining the outer edges is difficult, time consuming and expensive. Coining the outer edges is an additional manufacturing step which adds to the overall cost of manufacturing the contact. Furthermore, coining a radius on the outer edge can cause a rough edge that can scrape the plating, which is undesirable. Additionally, manufacturing compliant pins from a strip stock results in a large amount of scrap because the material between the contacts is scrapped.

A need remains for a contact having a compliant pin that can be manufactured in a cost effective and reliable manner. A need remains for a contact having a compliant pin that reduces or eliminates tool marks, scratches and/or stress concentration points to minimize fracturing.

### BRIEF DESCRIPTION OF THE INVENTION

In one embodiment, a contact is provided having a contact body that has a front, a rear and opposite sides that extend between the front and the rear. The contact body extends between a mating end and a mounting end. The mating end is configured to be mated with a corresponding mating contact. The mounting end is configured to be through-hole mounted to a printed circuit board. The mounting end has a profiled section that defines a compliant pin. The profiled section has a necked-down portion being thinner between the front and the rear than adjacent portions of the contact body. The profiled section has an opening through the necked-down portion. The profiled section has a compliant portion at the opening. The compliant portion is wider between the sides than adjacent portions of the contact body.

In another embodiment, a contact is provided having a contact body formed from a drawn wire. The drawn wire has a front, a rear and opposite sides that extend between the front and the rear. The contact body extends between a mating end and a mounting end. The mating end is configured to be mated with a corresponding mating contact. The mounting end is configured to be through-hole mounted to a printed circuit board. The mounting end has a profiled section defining a compliant pin. The profiled section has a coined, necked-down portion being thinner between the front and the rear than adjacent portions of the contact body. The profiled section has an opening through the necked-down portion. The profiled section has a compliant portion at the opening. The compliant portion is wider between the sides than adjacent portions of the contact body.

In a further embodiment, a contact is provided having a contact body formed from a stamped strip. The strip has a front, a rear and opposite sheared sides that extend between the front and the rear. The contact body extends between a mating end and a mounting end. The mating end is configured to be mated with a corresponding mating contact. The mounting end is configured to be through-hole mounted to a printed circuit board. The mounting end has a profiled section defining a compliant pin. The profiled section has a coined, necked-down portion being thinner between the front and the rear than adjacent portions of the contact body. The profiled section has an opening through the necked-down portion. The profiled section has a compliant portion at the opening. The compliant portion is wider between the sheared sides than adjacent portions of the contact body.

### BRIEF DESCRIPTION OF THE DRAWINGS

FIG. 1 illustrates a connector system having a contact formed in accordance with an exemplary embodiment.

FIG. 2 is a side view of a portion of a press for manufacturing a contact shown in FIG. 1.

FIG. 3 illustrates a contact at three different stages of manufacture.

FIG. 4 is a perspective view of a mounting end of the contact shown in FIG. 3.

FIG. 5 is a side view of the mounting end of the contact shown in FIG. 3.

FIG. 6 is a front view of the mounting end of the contact shown in FIG. 3.

FIG. 7 illustrates the contact loaded into a plated via of a PCB.

FIG. 8 illustrates three stages of manufacture of a contact formed in accordance with an exemplary embodiment.

FIG. 9 illustrates three stages of manufacture of a contact formed in accordance with an exemplary embodiment.

FIG. 10 illustrate an exemplary method of manufacturing a contact.

FIG. 11 illustrates an exemplary method of manufacturing of a contact.

### DETAILED DESCRIPTION OF THE INVENTION

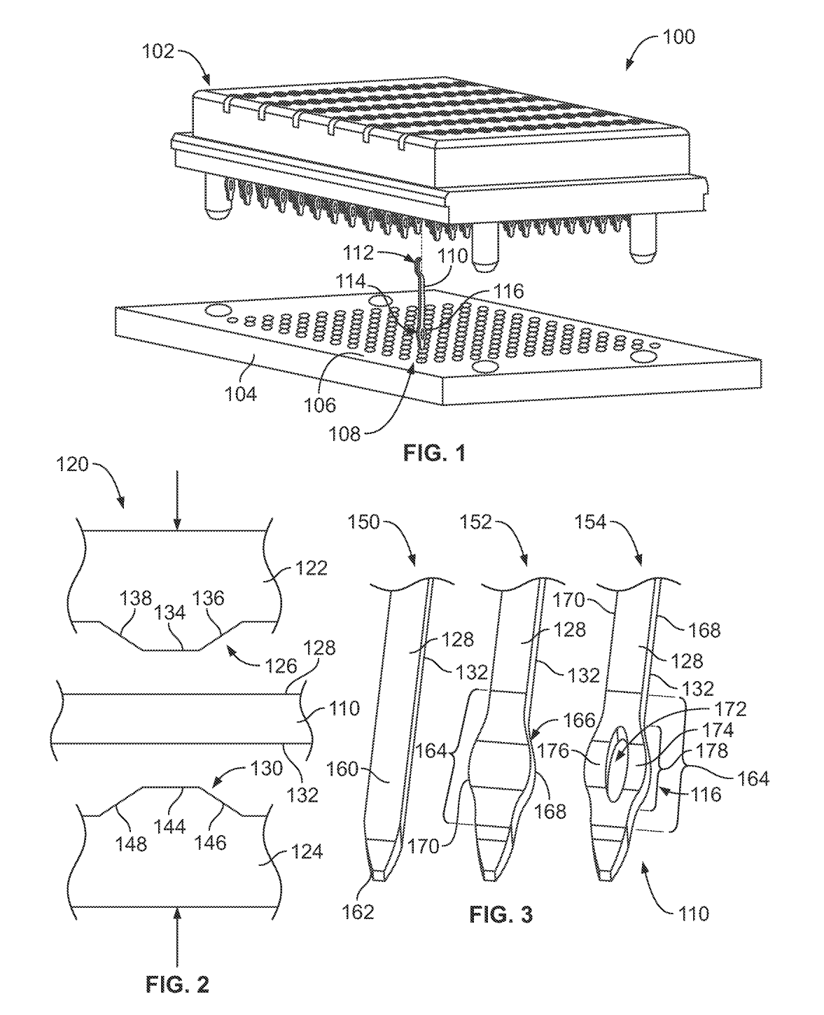

FIG. 1 illustrates a connector system 100 having contacts 110 formed in accordance with an exemplary embodiment. The connector system 100 includes an electrical connector 102 that is configured to be mounted to a printed circuit board (PCB) 104. The PCB 104 includes a mounting surface 106 and a plurality of plated vias 108 extending therethrough.

The electrical connector 102 includes a plurality of contacts 110 that are configured to be mounted to the PCB 104. The contacts 110 have a contact body 111 that extends between a mating end 112 and a mounting end 114. The mating end 112 is configured to be mated with a corresponding mating contact of another electrical connector. The mounting end 114 is configured to be through-hole mounted to a corresponding plated via 108 of the PCB 104. The mounting end 114 includes a compliant pin 116, such as an eye of the needle pin, that is received in the corresponding plated via 108 and makes electrical contact with the plated via 108.

The contacts 110 may have any size or shape depending on the particular application. In the illustrated embodiment, the contact 110 defines a vertical contact where the contact 110 extends along a contact axis with the mating end 112 and the mounting end 114 generally aligned along the contact axis. In alternative embodiments, the contacts 110 may other shapes. For example, the contacts 110 may be right angle contacts where the mating end 112 is oriented generally perpendicular with respect to the mounting end 114.

In the illustrated embodiment, the contact 110 constitutes a spring beam contact, where the mating end 112 is curved and is configured to be mated to a blade type contact. The mating end 112 may be deflected by the blade contact when mated thereto, creating a spring bias against the blade contact. In alternative embodiments, the contact 110 may be a pin type contact that is configured to be received in a socket contact. Alternatively, the contact 110 may be a socket contact configured to receive a pin contact. Other types of contacts are possible in alternative embodiments.

In an exemplary embodiment, the contact 110 is formed from a drawn wire that may be shaped during a metal forming manufacturing process into a desired configuration for mating with the mating contact and the PCB 104, as well as for being received in the electrical connector 102. The compliant pin 116 is formed from the drawn wire during the metal forming manufacturing process.

In an alternative embodiment, rather than being formed from a drawn wire, the contact 110 may be formed from a stamped strip, where the contact 110 is cut from a blank or work piece into a predetermined shape. The mating end 112 and mounting end 114 may then be shaped during a metal forming manufacturing process, such as to form the compliant pin 116. Other processes may be used to form the contacts 110 in alternative embodiments.

FIG. 2 is a side view of a portion of a press 120 used during the manufacturing process to form the contact 110. In an exemplary embodiment, a drawn wire is positioned in the press 120 for processing. In an alternative embodiment, a stamped strip is positioned in the press 120 for processing.

The press 120 includes an upper die 122 and a lower die 124 that are used to shape the contact 110. For example, the upper and lower dies 122, 124 may be used to form the compliant pin 116 (shown in FIG. 1). Optionally, both the upper and lower dies 122, 124 may be pressed into the contact 110 to form the compliant pin 116. Alternatively, only the upper die 122 or the lower die 124 may be moved, while the other die 122 or 124 is stationery. The upper die 122 includes a press surface 126 having a predetermined profile. The press surface 126 engages a front 128 of the contact 110 to shape the front 128 of the contact 110. The lower die 124 includes a press surface 130 having a predetermined profile. The press surface 130 engages a rear 132 of the contact 110 to shape the rear 132 of the contact 110.

In an exemplary embodiment, the press 120 is used to coin the contact 110 to form the compliant pin 116. During the coining operation, the contact 110 is subjected to sufficiently high forces or stresses to induce plastic flow on the front 128 and the rear 132 to change the shape of the contact 110. For example, the contact 110 may be thinned out between the front 128 and the rear 132, while also widening the contact 110 between the opposite sides in the region where the contact 110 is thinned.

In the illustrated embodiment, the press surface 126 includes a center section 134 and angled sections 136, 138 flanking the center section 134. The angled sections 136, 138 may be angled with respect to the center section 134 at any angle. The angles of the angled sections 136, 138 with respect to the center section 134 may be controlled to define the shape of the compliant pin 116. Optionally, the angled section 136 may be angled at a different angle than the angled section 138. The lengths of the center section 134 as well as the angled sections 136, 138 may be controlled to control the final shape of the compliant pin 116. Optionally, the length of the angled section 136 may different than the length of the angled section 138. The press surface 126 may include other sections in alternative embodiments, such as additional angled sections that are angled at different angles than the angled sections 136, 138.

The press surface 130 includes a center section 144 and angled sections 146, 148 flanking the center section 144. The angled sections 146, 148 may be angled with respect to the center section 144 at any angle. The angles of the angled sections 146, 148 with respect to the center section 144 may be controlled to define the shape of the compliant pin 116. Optionally, the angled section 146 may be angled at a different angle than the angled section 148. The lengths of the center section 144 as well as the angled sections 146, 148 may be controlled to control the final shape of the compliant pin 116. Optionally, the length of the angled section 146 may different than the length of the angled section 148. The press surface 130 may include other sections in alternative embodiments, such as additional angled sections that are angled at different angles than the angled sections 146, 148.

FIG. 3 illustrates the contact 110 at three different stages of manufacture 150, 152 154. Other stages of manufacture may occur prior to the stages illustrated, after the stages illustrated, or between the stages illustrated. For example, other manufacturing processes, such as stamping, cutting, forming, plating, polishing, grinding and the like may be performed on the contact 110.

In the first stage 150, a drawn wire 160 is provided. The drawn wire 160 has a tip 162 at an end thereof. The end of the drawn wire 160 is processed to form the compliant pin 116. The drawn wire 160 is presented at the press 120 (shown in FIG. 2) between the upper and lower dies 122, 124, which coin the drawn wire 160 to form a coined area defining a profiled section 164, illustrated at the second stage 152.

In the profiled section 164, the front 128 and rear 132 are pressed inward towards one another and flattened to a predetermined profile defined by the press surfaces 126, 130 (shown in FIG. 2). The contact 110 defines a necked-down portion 166 in the profiled section 164 between the front 128 and the rear 132. When the front 128 and the rear 132 are pressed inward, opposite sides 168, 170 of the drawn wire 160 are flared outward. The resulting outer profile of the sides 168, 170 is controlled by the profile of the press surfaces 126, 130. For example, changing the profiles of the press surfaces 126, 130 has a resulting change to the outer profile of the sides 168, 170.

In the profiled section 164, the contact 110 is wider from side 168 to side 170 than the side to side width of the drawn wire 160 interior (e.g., above) the profiled section 164. Optionally, the press surfaces 126, 130 may be profiled to form a bulbous or tear drop shape. The outer profile, defined by the sides 168, 170 has a continuous, convex curvature. In an exemplary embodiment, the outer profile is shaped to define an eye of the needle pin.

At the third stage 154, an opening 172 is provided in the profiled section 164. The opening 172 may be formed by piercing or punching through the profiled section 164. Other presses may be used to form the opening 172. First and second legs 174, 176 are defined on opposite sides of the opening 172. The first and/or second leg 174, 176 may be deflected when the compliant pin 116 is loaded into the PCB 104 (shown in FIG. 1). The area of the profiled section 164, having the opening 172, defines a compliant portion 178 of the contact 110.

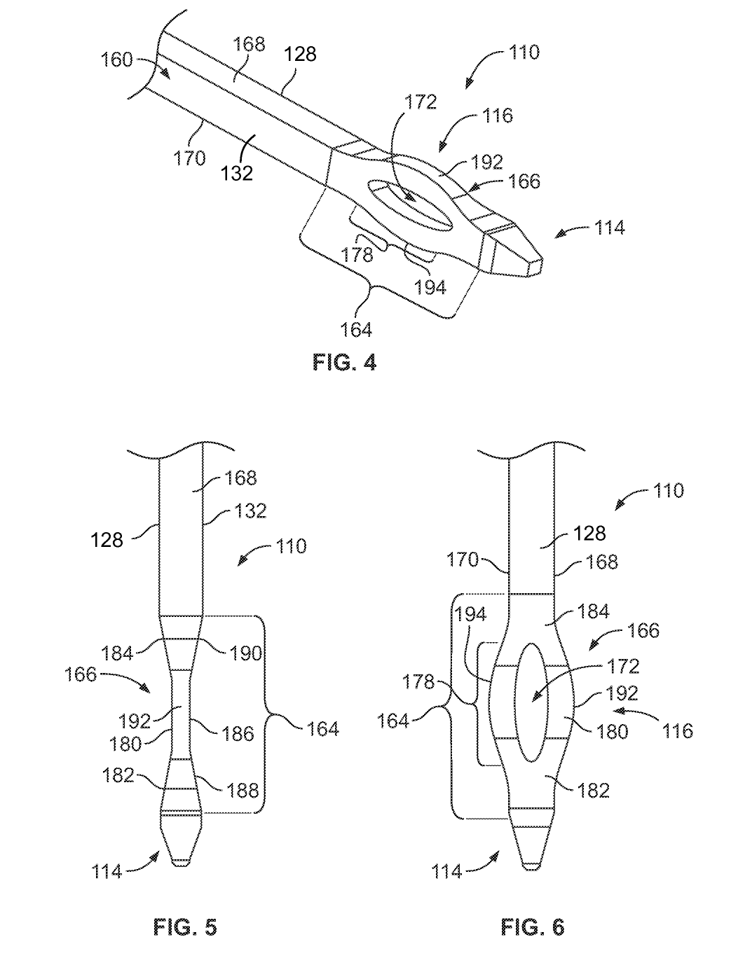

FIG. 4 is a perspective view of the mounting end 114 of the contact 110. FIG. 5 is a side view of the mounting end 114 of the contact 110. FIG. 6 is a front view of the mounting end 114 of the contact 110. In an exemplary embodiment, the contact 110 is formed from a drawn wire, such as the drawn wire 160 (shown in FIG. 3). The drawn wire includes the front 128, the rear 132 and the sides 168, 170. In an exemplary embodiment, the drawn wire is generally square shaped with the front 128, the rear 132 and the sides 168, 170 having approximately equal widths. In an exemplary embodiment, the front 128, the rear 132 and the sides 168, 170 may be approximately 0.64 mm and configured for use with a plated via 108 (shown in FIG. 1) having a diameter of approximately 1.00 mm. Other widths are possible in alternative embodiments for the plated vias 108 and for the drawn wire. In an alternative embodiment, rather than being square shaped, the drawn wire may have another shape, such as a rectangular shape, a circular shape, or another shape.

The contact 110 is manufactured to form the compliant pin 116 at the mounting end 114. In an exemplary embodiment, the contact 110 is coined to form the profiled section 164 and then punched to form the opening 172 to define the compliant portion 178.

As shown in FIG. 5, when the contact 110 is coined, the necked-down portion 166 is formed. The front 128 and/or the rear 132 may be necked-down. In the illustrated embodiment, both the front 128 and the rear 132 are necked-down. The contact 110 is thinner (between the front 128 and the rear 132) along the necked-down portion 166. Thinning of the contact 110 between the front 128 and the rear 132 allows the contact 110 to be loaded deeper into the plated via 108 before interference with the plating, increasing the likelihood that the compliant portion 178 is located within the plated via 108.

The front 128 includes a flat surface 180 and tapered surfaces 182, 184 flanking the flat surface 180. The lengths of the tapered surfaces 182, 184 as well as the angles of the tapered surfaces 182, 184 are controlled by the press surface 126 (shown in FIG. 2). Changing the profile of the press surface 126 would have a corresponding change to the profile of the front 128.

The rear 132 includes a flat surface 186 and tapered surfaces 188, 190 flanking the flat surface 186. The lengths of the tapered surfaces 188, 190 as well as the angles of the tapered surfaces 188, 190 are controlled by the press surface 130 (shown in FIG. 2). Changing the profile of the press surface 130 would have a corresponding change to the profile of the rear 132.

As shown in FIG. 6, in an exemplary embodiment, the opening 172 is punched through the thinnest part of the necked-down portion 166. For example, the opening 172 is punched through the flat surfaces 180, 186 and/or the thinnest parts of the tapered surfaces 182, 184, 188, 190. The distance between the flat surfaces 180, 186 may be approximately half the distance between the front 128 and the rear 132 interior of the profiled section 164. Punching through the thinnest part of the necked-down portion 166 makes it easier to punch through the contact 110. A smaller and/or less expensive punch may be used when punching through the thinnest part of the necked-down portion 166.

When the front 128 and the rear 132 are necked-down, outer surfaces 192, 194 of the sides 168, 170, respectively, are forced outward. In an exemplary embodiment, the outer surfaces 192, 194 of the sides 168, 170, at least in the compliant portion 178 may be rounded or curved between the front 128 and the rear 132. Such rounding occurs naturally when the front 128 and the rear 132 are coined. The rounding of the outer surfaces 192, 194 may be beneficial when coupling the compliant pin 116 to the plated via 108.

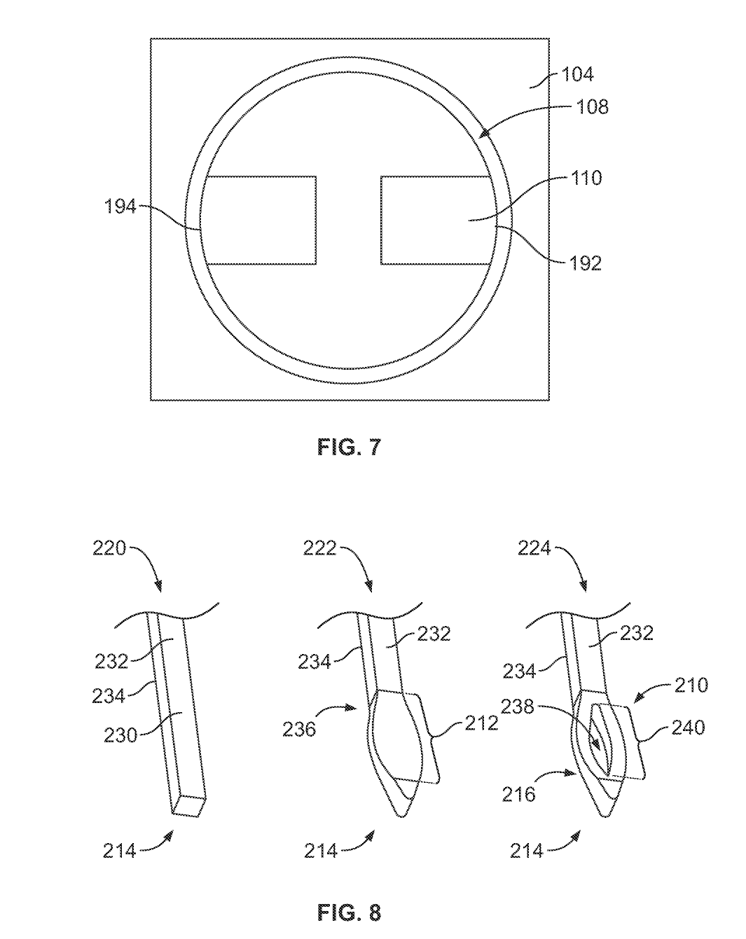

FIG. 7 illustrates the contact 110 loaded into the plated via 108 of the PCB 104. The rounded outer surfaces 192, 194 correspond with the radius of curvature of the plated via 108. Optionally, the outer surfaces 192, 194 may match the radius of curvature of the plated vias 108 to ensure good electrical contact with the plated vias 108.

FIG. 8 illustrates an alternative contact 210 having a different profiled section 212 than the profiled section 164 (shown in FIGS. 3-6). The contact 210 is processed to form a compliant pin 216 at a mounting end 214 of the contact 210. FIG. 8 illustrates the contact 210 during three stages of manufacture 220, 222, 224.

In the first stage 220, a drawn wire 230 is provided and may be presented to a press that has upper and lower dies that are profiled differently than the upper and lower dies 122, 124 (shown in FIG. 2). For example, the dies may be curved rather than having angled sections. At the second stage 222, the drawn wire 230 is coined to define the profiled section 212.

In the illustrated embodiment, the drawn wire 230 includes a front 232 and a rear 234 that are profiled to define a necked-down portion 236 that has continuously curved surfaces along the profiled section 212, rather than having flat surfaces and tapered surfaces, such as those provided on the contact 110.

At the third stage 224, an opening 238 is provided in the profiled section 212. The opening 238 extends through the thinnest part of the necked-down portion 236 between the front 232 and the rear 234. A compliant portion 240 of the contact 210 is defined within the necked-down portion 236 at the opening 238.

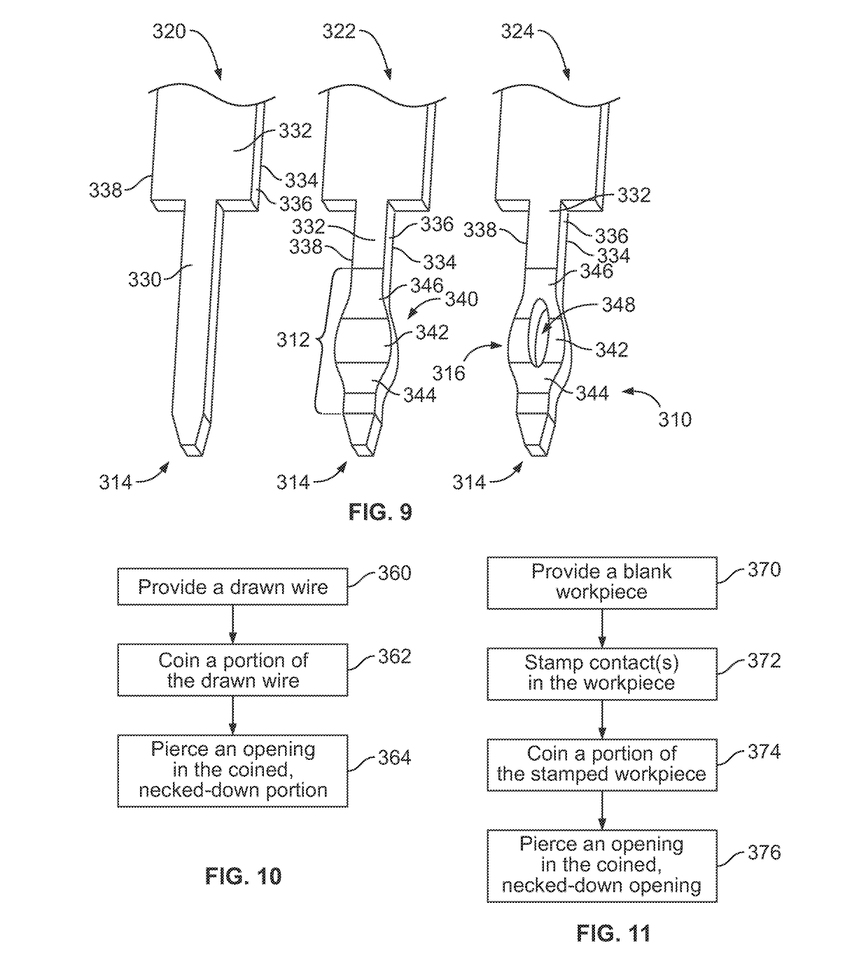

FIG. 9 illustrates an alternative contact 310 formed in accordance with an exemplary embodiment. The contact 310 is processed to form a profiled section 312 at a mounting end 314 of the contact 310. The profiled section 312 defines a compliant pin 316. FIG. 9 illustrates the contact 310 in three stages of manufacture 320, 322, 324.

In the first stage 320, a stamped strip 330 is provided. The stamped strip 330 is stamped from a blank or work piece. In an exemplary embodiment, a plurality of stamped strips 330 could be provided and connected along a carrier. The stamped strip 330 includes a front 332, a rear 334 and opposite sides 336, 338. During the stamping process that forms the stamped strip 330, the work piece is cut or sheared along the sides 336, 338. The sides 336, 338 define sheared sides, and may be referred to hereafter as sheared sides 336, 338.

At the second stage 322, the stamped strip 330 is coined to form the profiled section 312. When stamped, the sides 336, 338 are generally parallel to one another. The stamped strip 330 may be coined in a similar manner as the contact 110 (shown in FIGS. 3-6). The front 332 and the rear 334 are coined to define a necked-down portion 340, where the contact 310 is thinned between the front 332 and the rear 334 in the necked-down portion 340. In the illustrated embodiment, the front 332, at the necked-down portion 340, includes a flat surface 342 and tapered surfaces 344, 346 flanking the flat surface 342. The lengths of the tapered surfaces 344, 346 and/or the angles of the tapered surfaces 344, 346 with respect to the flat surface 342 may be controlled to control the outer profile of the sides 336, 338. For example, when the front 332 and the rear 334 are pressed inward, opposite sides 336, 338 of the stamped strip 330 are flared outward. The resulting outer profile of the sides 336, 338 is controlled by the profile of the press surfaces, such as the press surfaces 126, 130 of the press 120 (all shown in FIG. 2). For example, changing the profiles of the press surfaces has a resulting change to the outer profile of the sides 336, 338. In the profiled section 312, the contact 310 is wider from side 336 to side 338 than the side-to-side width of the stamped strip 330 adjacent (e.g., immediately above and/or immediately below) the profiled section 312. Optionally, the press surfaces of the press may be profiled to form a bulbous or tear drop shape. The outer profile, defined by the sides 336, 338, has a continuous, convex curvature. In an exemplary embodiment, the outer profile is shaped to define an eye of the needle pin.

When the profiled section 312 is coined, the sides 336, 338 are forced outward which tends to spread and/or almost entirely eliminates marks on the sides 336, 338 formed during the stamping or shearing process. Removing the scratch marks tends to eliminate fractures in the compliant pin 316 when loaded into the PCB 104 (shown in FIG. 1).

At the third stage 324, an opening 348 is provided in the profiled section 312. The opening 348 may be formed by piercing or punching through the profiled section 312. The opening 348 is punched or otherwise formed in the necked-down portion 340.

FIG. 10 illustrates an exemplary method of manufacturing a compliant pin. The method includes providing 360 a drawn wire. The method includes coining 362 a portion of the drawn wire to define a necked-down, widened profiled section of the drawn wire. The method includes piercing 364 an opening in the coined, necked down portion of the drawn wire.

FIG. 11 illustrates a method of manufacturing of a compliant pin. The method includes providing 370 a blank or work piece. The method includes stamping 372 one or more contacts or strips in the work piece. The method includes coining 374 a portion of the stamped strip to define a necked-down, widened profiled section of the stamped strip. The method includes piercing 376 an opening in the coined, necked-down portion of the stamped strip.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

1. A contact comprising:
a contact body having a front, a rear and opposite sides extending between the front and the rear, the contact body extending between a mating end and a mounting end;
the mating end being configured to be mated with a corresponding mating contact; and
the mounting end being configured to be through-hole mounted to a plated via of a printed circuit board, the mounting end having a profiled section defining a compliant pin, the profiled section having a necked-down portion being thinner between the front and the rear than adjacent portions of the contact body, the necked-down portion being coined such that the sides of the compliant portion are pressed outward for direct engagement with the plated via, the profiled section having an opening through the necked-down portion, the opening being centered between the sides, the profiled section having a compliant portion at the opening, the compliant portion being wider between the sides than adjacent portions of the contact body.

2. The contact of claim 1, wherein the compliant portion is defined within the necked-down portion.

3. The contact of claim 1, wherein at least one of the front or the rear are pressed during coining to define the necked-down portion.

4. The contact of claim 1, the sides of the compliant portion being pressed outward as the front and rear are coined.

5. The contact of claim 1, wherein both the front and the rear are tapered inward at the necked-down portion across the entire width of the necked-down portion.

6. The contact of claim 1, wherein, at the necked-down portion, the front includes a flat surface extending between the sides and tapered surfaces flanking above and below the flat surface.

7. The contact of claim 1, wherein the contact body, interior of the necked-down portion, is generally square shaped with the front, rear and the sides being of approximately equal widths.

8. The contact of claim 1, wherein the contact body is formed from a drawn wire, the drawn wire being coined to define the necked-down portion and the compliant portion.

9. The contact of claim 1, wherein the contact body is formed from a stamped strip, the sides being sheared sides that are cut when the stamped strip is formed, the sides being sheared parallel to one another and then being pressed outward after being sheared to define the compliant portion when the necked-down portion is coined.

10. The contact of claim 1, wherein the opening is punched through the thinnest part of the necked-down portion.

11. A contact comprising:
a contact body formed from a drawn wire, the drawn wire having a front, a rear and opposite sides extending between the front and the rear, the contact body extending between a mating end and a mounting end;
the mating end being configured to be mated with a corresponding mating contact; and
the mounting end being configured to be through-hole mounted to a printed circuit board, the mounting end having a profiled section defining a compliant pin, the profiled section having a coined, necked-down portion being thinner between the front and the rear than adjacent portions of the contact body, the profiled section having an opening through the necked-down portion, the opening being centered between the sides, the profiled section having a compliant portion at the opening, the sides being flared outward through the necked-down portion by the coining such that the sides are wider along the necked-down portion than adjacent portions of the contact body.

12. The contact of claim 11, wherein the compliant portion is defined within the necked-down portion.

13. The contact of claim 11, wherein the sides of the compliant portion are pressed outward as the front and rear are coined.

14. The contact of claim 11, wherein, at the necked-down portion, the front includes a flat surface extending between the sides and tapered surfaces flanking above and below the flat surface, and wherein, at the necked down portion, the rear includes a flat surface extending between the sides and tapered surfaces flanking above and below the flat surface.

15. The contact of claim 11, wherein the contact body, between the necked-down portion and the mating end, is generally square shaped with the front, rear and the sides being of approximately equal widths.

16. A contact comprising:
a contact body formed from a stamped strip, the strip having a front, a rear and opposite sheared sides extending between the front and the rear, the contact body extending between a mating end and a mounting end;
the mating end being configured to be mated with a corresponding mating contact; and
the mounting end being configured to be through-hole mounted to a printed circuit board, the mounting end having a profiled section defining a compliant pin, the profiled section having a coined, necked-down portion being thinner between the front and the rear than adjacent portions of the contact body, the profiled section having an opening through the necked-down portion, the opening being centered between the sides, the profiled section having a compliant portion at the opening, the sheared sides being flared outward through the necked-down portion by the coining such that the sheared sides are wider along the necked-down portion than adjacent portions of the contact body.

17. The contact of claim 16, wherein the compliant portion is defined within the necked-down portion.

18. The contact of claim 16, wherein the sides of the compliant portion are pressed outward as the front and rear are coined after the sides are sheared.

19. The contact of claim 16, wherein, at the necked-down portion, the front includes a flat surface extending between the sides and tapered surfaces flanking above and below the flat surface, and wherein, at the necked down portion, the rear includes a flat surface extending between the sides and tapered surfaces flanking above and below the flat surface.

20. The contact of claim 16, wherein the contact body, between the necked-down portion and the mating end, is formed into a box-shaped socket.
